(19) United States
(12) Patent Application Publication
(10) Pub. No.: US 2025/0060868 A1
(43) Pub. Date: Feb. 20, 2025

(54) Verfahren zum Konfigurieren eines SPS-Geräts und ein SPS-Verwaltungssystem zum Ausführen des Verfahrens

(71) Applicant: SICK AG, Waldkirch (DE)

(72) Inventor: Sebastian HEIDEPRIEM, Winden i.E. (DE)

(21) Appl. No.: 18/807,035

(22) Filed: Aug. 16, 2024

(30) Foreign Application Priority Data
Aug. 17, 2023 (EP) 23191936.6

(51) Int. Cl. G06F 3/04847; G05B 19/05

(52) U.S. Cl. CPC G06F 3/04847; G05B 19/05; G05B 2219/1143

(57) ABSTRACT

A method for configuring a PLC device includes a first application being executed with a first graphical user interface. Furthermore, at least one user input is detected on the first graphical user interface. Subsequently, configuration information is generated with at least one configuration parameter for the at least one PLC device based on the detected user input. Furthermore, a second application is executed with a second graphical user interface. Subsequently, a transmission of the configuration information from the first application to the second graphical user interface of the second application takes place. Then, PLC configuration information is generated based on the configuration information by means of the second application. A transmission of the PLC configuration information to the at least one PLC device by the PLC central unit then takes place. Finally, the PLC device loads the received PLC configuration information.

The invention relates to a method for configuring a PLC device and to a PLC management system for carrying out the method.

PLC systems (Programmable Logic Controllers (PLC)) are computer-controlled systems that are widely used in automation technology. The main function of a PLC system is to control and monitor industrial processes. In particular, processes in factories, machines and in building automation are controlled with a PLC system.

A PLC system in particular comprises a PLC central unit and PLC devices accordingly connected to the PLC central unit. There is also application software via which the PLC system can be programmed and configured. A PLC system preferably works in real time and is in particular suitable for automating processes that require a high accuracy, reliability and speed.

Depending on the manufacturer, PLC configurations comprise the configuration of an entire system. As a rule, this configuration not only determines the PLC program of the controls used, but also the configuration of the connected components. In the case of PROFINET, the configuration of individual modules of a component is transmitted once at the start of the system.

For this purpose, the PLC configuration tool often provides a generic interface that allows parameters to be set.

Modern PLC components such as sensors, actuators or even many machines are now too complex to be able to be configured using a few simple parameters that can be configured in the PLC. For example, there are applications for sensors that have coordinated graphical user interfaces (operator interfaces) via which the user can parameterize the PLC device as intuitively as possible. This graphically supported approach of a user interface cannot be replaced by the generic approach of parameters.

It is therefore the object of the present invention to provide a method with which PLC devices can be very easily managed and configured.

The object is satisfied by the method according to the invention for configuring a PLC device according to claim 1 and by the PLC management system according to claim 15. Advantageous further developments of the method according to the invention are set forth in claims 2 to 14.

The method according to the invention serves to configure a PLC device, which is connected to a PLC central unit, by means of PLC configuration information. In a first method step, a first application is executed and a first graphical user interface for generating configuration information for the at least one PLC device is displayed by the first application. In a second method step, at least one user input is detected on the first graphical user interface by the first application. In a third method step, the configuration information is generated with at least one configuration parameter for the at least one PLC device based on the detected user input by means of the first application. In a fourth method step, a second application is executed and a second graphical user interface for controlling the PLC central unit is displayed by the second application. In a fifth method step, the configuration information is transmitted from the first application, in particular to an input field for configuring the at least one PLC device on the second graphical user interface of the second application. In a sixth method step, PLC configuration information is generated based on the configuration information by means of the second application. In a seventh method step, the PLC configuration information is transmitted to the at least one PLC device by the PLC central unit. Preferably, in an eighth method step, the PLC configuration information received by the PLC device is loaded by the PLC device.

In other words, the first graphical user interface specifically designed for configuring the PLC device can be used for configuring the PLC device, wherein the transmission of the configuration to the PLC device nevertheless takes place centrally by the PLC central unit. The first graphical user interface can e.g. be “Engineering UI”. For this purpose, the configuration information that was generated in the first graphical user interface is simply transmitted to the second graphical user interface and thus made available to the PLC central unit. More precisely, the configuration information can e.g. be stored in the project, e.g. in a project file containing the configuration of the PLC central unit, and can then be transmitted to the PLC device on each system start of the PLC central unit. A direct connection between the first application and the PLC device is not necessary. Furthermore, the distribution of the configuration to a plurality of similar systems can easily be implemented. Copying a configuration to a plurality of similar PLC devices can also be easily achieved by using the configuration information multiple times.

It is therefore particularly advantageous that the entire composition of the configuration of the PLC device, i.e. the creation of the configuration information for the PLC device, preferably takes place via a (single) graphical user interface. The user thereby has all the advantages that a user interface precisely tailored to the PLC device can offer. Furthermore, it is advantageous that this configuration information, which is generated by the first application, is transmitted to the second application that generates the required PLC configuration information from the configuration information. This second application serves to control and/or configure the PLC central unit. In this case, the second application does not have to contain the user interface that is precisely tailored to the PLC device. It is thereby sufficient if the second application only contains those components that are necessary for the general control of a PLC management system. The second application therefore does not need to be provided with an intuitive user interface for each connected PLC device. The configuration of a PLC management system can thereby be performed particularly easily.

In short, the advantage of the simple and comprehensive configuration by the first user interface is combined with the simple distribution of the configuration by the second application.

The PLC device can in particular be a field device that is configured as a sensor or an actuator, for example. The PLC device can e.g. comprise a monitoring sensor, such as a laser scanner or a light grid, a motor control and the like. A different first application and a different first graphical user interface, which are adapted to the setting options of the respective PLC device, can respectively be used for different PLC devices. It is understood that, in order to configure different PLC devices, different first applications of this kind can also be used, in particular successively, to generate different configuration information for different PLC devices and to transmit the different configuration information to the (single) second application in order, ultimately, to perform a configuration of the different PLC devices by the PLC central unit.

The PLC device preferably uses the PLC configuration information in its operation, wherein the operating behavior of the PLC device is changed or adapted by the PLC configuration information. More precisely, the PLC device reacts to the reception of the PLC configuration information, preferably by resetting parameters, in particular configuration-relevant variables, to standard or default values and then processes the PLC configuration information by setting the parameter values accordingly as specified in the PLC configuration information. The behavior of the PLC device, e.g. in an industrial process, can therefore be changed or adapted via the PLC configuration information.

In a further development according to the invention, the first application and the second application are executed by the same computer system. This is in particular a client computer system. The application can be designed as a local installation or a remote installation. A remote installation can be a web-based cloud installation, for example. The user thereby has an optimal overview to be able to configure the PLC device individually by means of the first graphical user interface and also simultaneously sees the configuration options for the entire PLC management system. It is also conceivable that the first application is a local installation and the second application is provided by a web server on the PLC central unit.

In a further development according to the invention, the at least one configuration parameter comprises a name-value pair. A plurality of configuration parameters are preferably encoded in consecutive name-value pairs in the configuration information. A name-value pair can, for example, be a variable that is assigned a specific value. For example, the update frequency of a PLC device, in the form of a PLC monitoring sensor, can represent the at least one configuration parameter as a name-value pair. A very easy assignment of the property of the PLC device to be configured to the actual value is thereby possible. A name-value pair can be represented or generated by a so-called Cloning String, for example. In addition to name-value pairs, CoLaA* write commands using variable names can also be used to generate the name-value pair. CoLaA is a protocol based on visible (ASCII values 0x20 . . . 0x1F) ASCII characters.

If there are a plurality of name-value pairs, they can be present in a common string and e.g. separated by a predefined separator (e.g. “;”). The name-value pairs can in particular be saved as JSON (JavaScript Object Notation) or XML (extendable Markup Language), for example as a JSON and/or XML file.

In an advantageous further development, the name-value pair or the plurality of name-value pairs comprises the detected setting by the user input of an element on the first graphical user interface. In other words, for example, a property of the PLC device, such as the update frequency of a PLC monitoring sensor, can be set to a specific value via a check box on the first graphical user interface. At least one or all the elements that can be selected by the user on the graphical user interface have a name, wherein a corresponding value is assigned to this name depending on the selection and the combination as a name-value pair represents the configuration parameter that forms the configuration information.

In an advantageous further development, the at least one configuration parameter is included in plain text and unencrypted in the configuration information. This is particularly advantageous since the user can thereby see and understand this configuration parameter and can optionally adapt it even further. Preferably, the configuration parameter is also unsigned.

In an advantageous further development, the configuration information is transmitted, preferably as text, from the first application to the input field of the second graphical user interface of the second application by a copy/paste command. For example, a function button in the first graphical user interface can copy the configuration to the (Windows) clipboard. As a result, no complex API is required and already existing software for managing the PLC management system can continue to be used without problem and without adaptation. Preferably, the user simply presses Copy and presses Paste in the second application. This procedure can comprise copying to a clipboard in the operating system. Naturally, such a transmission from the first to the second application can also be performed by an API (Application Programming Interface). For this purpose, the second application can provide an API via which the first application transmits the configuration information to the second application.

In an advantageous further development, the PLC configuration information corresponds to the configuration information. In this case, the configuration information created by the first application can be transmitted directly to the corresponding PLC device via the PLC central unit. Alternatively, the PLC configuration information is derived from the configuration information. The PLC configuration information differs, for example, by an encoding and/or encryption and/or signing and/or a different layout. In this case, it no longer necessarily has to be available in plain text.

In an advantageous further development, only for that property of the PLC device that is configured via the first graphical user interface, a configuration parameter is added to the configuration information that is (actively) defined by the user input. If the user can, for example, set 30 properties of the PLC device via the first user interface and only does so for five properties, only five configuration parameters are also added to the configuration information. It is particularly advantageous here that the configuration information is kept clear.

In an advantageous further development, only for that property of the PLC device that is configured via the first graphical user interface, a configuration parameter is added to the configuration information that has a value that differs from a standard value. If the standard value for an update frequency of a PLC device in the form of a PLC monitoring sensor is, for example, 120 Hz and this value is changed to 100 Hz, a configuration parameter is generated based on the deviation from the standard value and is added to the configuration information. If the update frequency is not changed, no configuration parameter is generated. In this case, when using general Cloning Strings, it generally applies that all variables, i.e. properties of the PLC device that can be changed by the first graphical user interface, are compared with default values. In this respect, only the variables that have a different value to their default values are then included in the Cloning Strings. This significantly reduces the overall size of the Cloning Strings. In this case, a Differential Cloning String is also mentioned.

Furthermore, the PLC configuration information, in particular in the form of a Differential Cloning String, can also include a reference to one of a plurality of sets of standard values. If a reference to a set of standard values is included, the PLC device can use the corresponding standard values in each case. For example, a first set of standard values can produce an energy-saving operation, whereas a second set of standard values enables an operation with e.g. a high sampling rate. For the first set of standard values, for example, the sampling rate or the update frequency may be reduced compared to the second set.

The PLC configuration information can likewise include verification information, for example, in the form of a checksum or a hash. The PLC device can hereby check whether the PLC configuration information has been correctly transmitted.

An example of at least a portion of PLC configuration information is given below:

{Backup:{Target:“CLV690-100-
SWV1.23.0”},{Default:“Factory4”},{Parameter:[{Exp:1.23},{Span:45},
...”},...],{ChkSum:0x14D 4}

It can be seen that the PLC configuration information includes the PLC device to be configured (“Target”) and a reference to a fourth set of standard values (“Default: “Factory4”). The PLC configuration information furthermore comprises information about an exposure time (“EXP”) and the range to be detected (“Span”). Additional information may also be included. Finally, the PLC configuration information also comprises a checksum.

In an advantageous further development, independently of the property of the PLC device that is configured via the first user interface, at least one configuration parameter, which has a specific value, is added to the configuration information. In other words, at least one configuration parameter is always added to the configuration information, and indeed regardless of whether the property on which this configuration parameter is based has been changed via the first graphical user interface. This can be referred to as a so-called “whitelisting”. A preselection of these configuration parameters that necessarily have to be transmitted can generally be available and can also be changed via the first graphical user interface, for example. Such a preselection can be useful so that the user has a deeper understanding of how the PLC device works when the user looks through the configuration information available in plain text.

In an advantageous further development, at least one configuration parameter is added to the configuration information for a property of the PLC device that is configured via the first user interface. Furthermore, a further configuration parameter is added to the configuration information, said further configuration parameter depending on that configuration parameter whose property was configured or changed via the first user interface. The corresponding dependencies can be specific to the respective PLC device and are processed by the first application.

In an advantageous further development, a configuration parameter is added to the configuration information for each property of the PLC device that can be configured via the first user interface. In this case, the configuration information comprises all the configuration parameters that can be set via the first graphical user interface.

In an advantageous further development, one, more or all of these configurable properties of the PLC device are defined by a user input. This means that all the configuration parameters are added to the configuration information. This applies both to configuration parameters whose underlying properties have been defined by the user input and to those configuration parameters whose underlying properties have not been defined by a user input.

In an advantageous further development, a configuration parameter is never added to the configuration information for a predetermined property of the PLC device that can be configured via the first user interface. It is thereby achieved that the PLC device cannot be configured with respect to specific properties, e.g. blocked properties. This can be referred to as a so-called “blacklisting”. For example, it is conceivable that a user may not change a property according to which the PLC device, for example in the form of a monitoring sensor, is only active at certain times.

In an advantageous further development, the first application is configured to display different configurable properties for the PLC device to the user on the first graphical user interface, depending on the user rights of the user. For example, user A can be displayed further configurable properties for the PLC device than user B.

In an advantageous further development, the PLC device initializes configuration parameters that are not included in the PLC configuration information with a standard value. Therefore, only the currently set configuration parameters must be transmitted to the PLC device.

In an advantageous further development, the PLC device transmits its current configuration as configuration information to the PLC central unit, wherein the PLC central unit is configured to transmit the configuration information of the PLC device to the first application that is in turn configured to receive it and to display the received configuration information of the PLC device on the first graphical user interface. A user can thereby make additional changes on the familiar user interface. The transmission of the received configuration information from the first application to the second application can take place via a copy/paste command. It is also conceivable that the received configuration information only comprises those configuration parameters that differ from a standard setting. The second application then uses standard values for configuration parameters that are not included in the configuration information.

In an advantageous further development, the first application is configured to display a selection menu on the first graphical user interface, said selection menu allowing the user to select the PLC device to be configured, wherein different GUI elements appear on the first graphical user interface depending on the PLC device selected. This is in particular advantageous if a manufacturer of a PLC device has various PLC devices (sensors, actuators, machines) in its range and thus only has to update an application and the user only has to install a first application.

In an advantageous further development, the first application comprises more elements on the first graphical user interface for configuring the corresponding PLC device than the second application on the second graphical user interface. The second application preferably does not comprise any elements on the second graphical user interface that can be used to configure the corresponding PLC device.

The PLC management system according to the invention comprises a PLC central unit, at least one PLC device and a computer system. The at least one PLC device and the computer system are connected to the PLC central unit. The computer system is configured to execute the first and the second application. The PLC management system is configured to carry out the initially described method.

In an advantageous further development, the at least one PLC device is connected to the PLC central unit via PROFINET.

In an advantageous further development, the computer system is connected to the PLC central unit via an Ethernet connection or WIFI connection or mobile radio connection or Bluetooth® connection. The PLC central unit can preferably be connected to the PLC device via a wired data connection, in particular a field bus, e.g. PROFINET, EtherCAT, SERCOS, EtherNet/IP and the like.

The invention will be described purely by way of example with reference to the drawings in the following. There are shown:

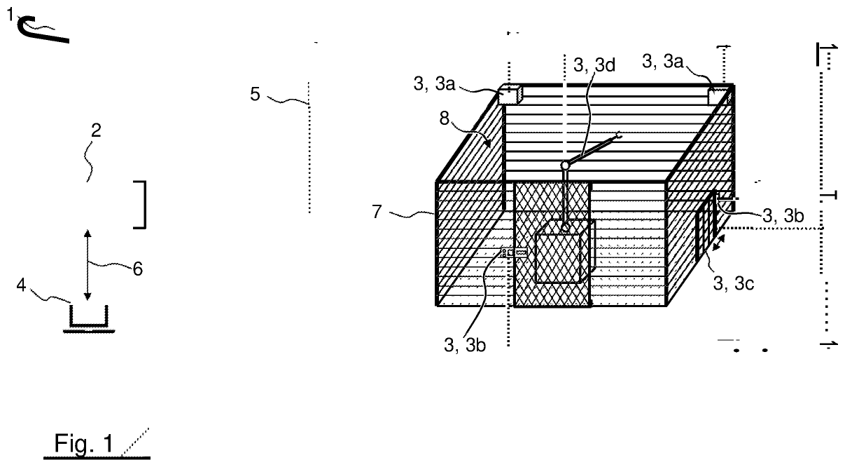

FIG. 1: An overview of the PLC management system comprising a plurality of PLC devices, a PLC central unit and a computer system;

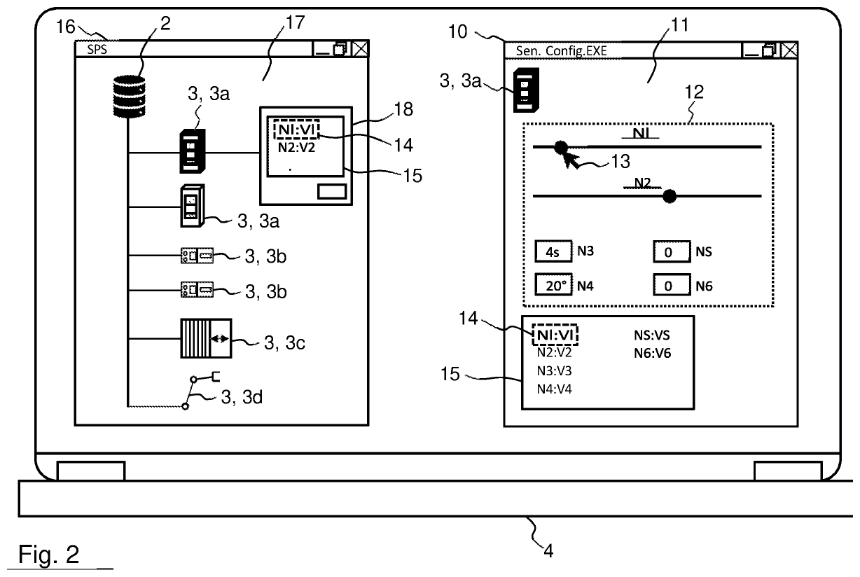

FIG. 2: the computer system on which the first and the second application are executed; and

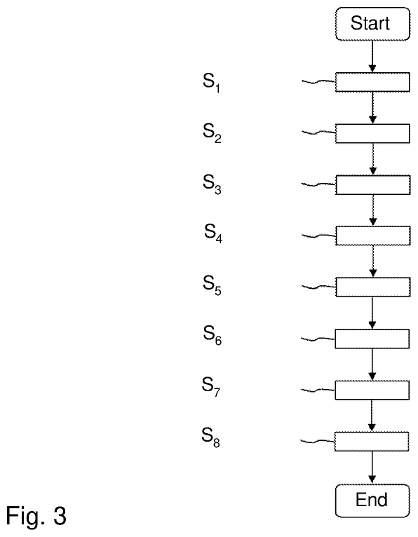

FIG. 3: a flowchart that shows a method for configuring a PLC device.

FIG. 1 shows an overview of the PLC management system 1 according to the invention. The PLC management system comprises a PLC central unit 2, at least one PLC device 3 and a computer system 4. The at least one PLC device 3 is connected to the PLC central unit 2 via a first data connection 5, in particular via a PROFIBUS. The computer system 4 is connected to the PLC central unit 2 via a second data connection 6, in particular via an Ethernet connection or WIFI connection or mobile radio connection or Bluetooth® connection.

In this embodiment example, the at least one PLC device 3 comprises a monitoring sensor 3a, a safety locking device 3b, a door 3c and a machine 3d.

The machine 3d is arranged in a space 8 delimited by a grid 7. The monitoring sensors 3a are configured to detect the presence of a person in the space 8 to be monitored. The safety locking devices 3b are configured to detect whether a door 3c leading into the space 8 is open or closed and/or to lock this door 3c. The door 3c can also have a drive, wherein the opening speed is e.g. settable.

The PLC central unit 2 controls the PLC devices 3 during the start and during the operation of the PLC management system 1. The PLC devices 3 can be configured via the computer system 4. The PLC central unit 2 can also be configured via the computer system 4.

FIG. 2 shows the computer system 4 and explains how the PLC devices 3 can be configured via the computer system 4. The computer system 4 is configured to execute a first application 10. The first application 10 comprises a first graphical user interface 11. In this embodiment example, the first application 10 serves to configure a PLC device 3 in the form of the monitoring sensor 3a. The graphical 20 user interface 11 of the first application 10 is explicitly tailored to the possible settings of the monitoring sensor 3a. A user can therefore configure the monitoring sensor 3a very intuitively.

There can generally be a separate first application 10 for each PLC device 3. It is also conceivable that there is only a first application 10 and that the user selects the PLC device 3 to be configured when starting this first application 10. Depending on this selection, the first application 10 would then be configured to display the suitable first user interface 11 with which the user can configure the selected PLC device 3.

In the embodiment example, the user can configure six different properties 12 of the PLC device 3 in the form of the monitoring sensor 3a. The properties 12 to be configured have the names N1, N2, N3, N4, N5 and N6. The properties 12 can be set via various GUI elements. In this embodiment example, the first user interface 11 of the first application 10 provides sliders and input fields. Naturally, there can also be drop-down menus or radio buttons.

The user can perform the configuration via an input device such as a keyboard and/or a mouse. Naturally, the configuration can also be performed by touching a touch-sensitive screen. In this embodiment example, a mouse pointer 13 is shown that currently clicks on a slider to change the value of the property 12 with the name N1. For example, it is conceivable that the user changes the update frequency of the monitoring sensor 3a via the slider.

Each property 12 of the PLC device 3 which the user can configure comprises a name and a corresponding value. In this embodiment example, the names are labeled as N1, N2, N3, N4, N5 and N6. In this embodiment example, the values are designated as V1, V2, V3, V4, V5 and V6.

Such a name-value pair, i.e. N1 with V1, can also be designated as configuration parameter 14. The configuration parameters 14 are in particular available in plain text so that a user can check very quickly whether he has made the correct settings for the PLC device 3.

The first application 10 is configured to recognize user inputs on the first graphical user interface 11 and, depending on the changes made to the properties 12, to generate corresponding configuration parameters 14 and to add them to configuration information 15. Configuration information 15 can therefore include one or more configuration parameters 14.

The first application 10 is configured to generate configuration parameters 14 for all the properties 12 of the PLC device that are to be set and to add said configuration parameters to the configuration information 15. However, the first application 10 is preferably configured to generate configuration parameters 14 only for those properties 12 of the PLC device 3 that are to be set and to add said configuration parameters to the configuration information 15 that has been changed and/or that deviates from a predefined standard value. The size if the configuration information 15 can thereby be kept small.

The computer system 4 is further configured to execute a second application 16. The second application 16 comprises a second graphical user interface 17. In this embodiment example, the second application 16 serves to configure the PLC central unit 2. PLC devices 3 that are connected to the PLC central unit 2 are, for example, displayed on the second graphical user interface 17. The user can, for example, select one of these PLC devices 3. In this case, the user has selected the monitoring sensor 3a. In this embodiment example, the selection is visualized in that the image for the selected PLC device 3 is displayed in a slightly stronger color or in a different color or with a border. At the same time, the second application 16 is configured to display an input field 18 in which the configuration information 15 generated by the first application 10 can be inserted. This insertion can take place by a copy/paste command. In FIG. 2, the configuration information 15 with the configuration parameters 14 from the first application 10 is inserted into the corresponding input field 18 of the second graphical user interface 17 of the second application 16. The second application 16 is configured to generate PLC configuration information from the configuration information 15. This PLC configuration information is transmitted to the PLC central unit 2 by means of the second application 16. The PLC central unit 2 is configured to transfer this PLC configuration information to the connected corresponding PLC device 3. The corresponding PLC device 3 is in turn configured to load the received PLC configuration information and to configure itself according to this PLC configuration information.

FIG. 3 shows a flowchart that illustrates a method for configuring a PLC device 3. In a first method step S1, a first application 10 is executed and a first graphical user interface 11 for generating configuration information 15 for the at least one PLC device 3 is displayed by this first application 10. In a second method step S2, at least one user input is detected on the first graphical user interface 11 by the first application 10. In a third method step S3, the configuration information 15 is generated with at least one configuration parameter 14 for the at least one PLC device 3 based on the detected user input by means of the first application 10. In a fourth method step S4, a second application 16 is executed and a second graphical user interface 17 for controlling the PLC central unit 2 is displayed by said second application 16. In a fifth method step S5, the configuration information 15 is transmitted from the first application 10, in particular to an input field for configuring the at least one PLC device 3 on the second graphical user interface 17 of the second application 15. In a sixth method step S6, PLC configuration information is generated based on the configuration information 15 by means of the second application 16. In a seventh method step S7, the PLC configuration information is transmitted to the at least one PLC device 3 by the PLC central unit 2. In an eighth method step S8, the PLC configuration information received by the PLC device 3 is loaded by the PLC device 3.

The invention is not restricted to the embodiment examples described. Within the framework of the invention, all the described and/or drawn features can be combined with one another in any desired manner, unless stated otherwise.

Reference numeral list

| | |
|---|---|
| PLC management system | 1 |
| PLC central unit | 2 |
| PLC device | 3 |
| Monitoring sensor (PLC) | 3a |
| Safety locking device (SPS) | 3b |
| Door (SPS) | 3c |
| Machine (PLC) | 3d |
| Computer system | 4 |
| First data connection | 5 |
| Second data connection | 6 |
| Grid | 7 |
| Space | 8 |
| First application | 10 |
| First graphical user interface | 11 |
| Properties of the PLC device | 12 |
| Mouse pointer | 13 |
| Configuration parameter | 14 |
| Configuration information | 15 |
| Second application | 16 |
| Second graphical user interface | 17 |
| Input field | 18 |
| Method steps | S₁, S₂, S₃, S₄, S₅, S₆, S₇, S₈ |
| SICK AG | S29556PEP - Br/Sl |

1. A method for configuring a PLC device, which is connected to a PLC central unit, with PLC configuration information, said method comprising the following method steps:
executing a first application and displaying a first graphical user interface for generating configuration information for the at least one PLC device by the first application;
detecting at least one user input on the first graphical user interface by the first application;
generating the configuration information with at least one configuration parameter for the at least one PLC device based on the detected user input by means of the first application;
executing a second application and displaying a second graphical user interface for controlling the PLC central unit by the second application;
transmitting the configuration information from the first application to an input field for configuring the at least one PLC device on the second graphical user interface of the second application;
generating the PLC configuration information based on the configuration information by means of the second application;
transmitting the PLC configuration information to the at least one PLC device by the PLC central unit.

2. The method according to claim 1,
wherein the first application and the second application are executed by the same computer system.

3. The method according to claim 1 or 2,
wherein the at least one configuration parameter comprises one name-value-pair or a plurality of name-value pairs.

4. The method according to claim 3,
wherein the name-value pair or the plurality of name-value pairs comprises the detected setting by the user input of an element on the first graphical user interface.

5. The method according to claim 1,
wherein the at least one configuration parameter is included in plain text and unencrypted in the configuration information.

6. The method according to claim 1,
wherein the configuration information is transmitted from the first application to the input field of the second graphical user interface of the second application by a copy/paste command.

7. The method according to claim 1,
wherein the PLC configuration information corresponds to the configuration information or wherein the PLC configuration information is derived from the configuration information.

8. The method according to claim 1,
wherein, only for that property of the PLC device that is configured via the first graphical user interface, a configuration parameter is added to the configuration information that is defined by the user input.

9. The method according to claim 1,
wherein, only for that property of the PLC device that is configured via the first graphical user interface, a configuration parameter is added to the configuration information that has a value that differs from a standard value.

10. The method according to claim 9,
wherein, independently of the property of the PLC device that is configured via the first user interface, at least one configuration parameter, which has a specific value, is added to the configuration information.

11. The method according to claim 1,
wherein a configuration parameter is added to the configuration information for each property of the PLC device that can be configured via the first user interface.

12. The method according to claim 11,
wherein one, more or all of these configurable properties of the PLC device are defined by a user input.

13. The method according to claim 11,
wherein a configuration parameter is never added to the configuration information for a specific property of the PLC device that can be configured via the first user interface.

14. The method according to claim 1,
wherein the PLC device initializes configuration parameters that are not included in the PLC configuration information with a standard value.

15. A PLC management system comprising a PLC central unit, at least one PLC device and a computer system, wherein the at least one PLC device and the computer system are connected to the PLC central unit, wherein the computer system is configured to execute the first application and the second application, wherein the PLC management system is configured to carry out the method according to claim 1.
